(19) United States
(12) Patent Application Publication
(10) Pub. No.: US 2016/0104322 A1
(43) Pub. Date: Apr. 14, 2016

(54) APPARATUS FOR GENERATING A DISPLAY CONTROL SIGNAL AND A METHOD THEREOF

(71) Applicant: Infineon Technologies AG, Neubiberg (DE)

(72) Inventors: Gerwin FLEISCHMANN, Aigen im Ennstal (AT); Christoph HEIDENREICH, Graz (AT)

(21) Appl. No.: 14/878,606

(22) Filed: Oct. 8, 2015

(30) Foreign Application Priority Data
Oct. 10, 2014 (DE) 102014114742.1

(51) Int. Cl. G06T 19/00; G06F 3/01; G02B 27/01

(52) U.S. Cl. CPC G06T 19/006; G02B 27/017; G06F 3/016; G06F 3/017

(57) ABSTRACT

An apparatus for generating a display control signal includes an input module configured to receive a detection signal including information related to a position of a user indicator or a distance between a user indicator and an event point associated with a virtual target. The apparatus further includes a processing module configured to generate a display control signal including display information for producing an image of the virtual target by a display device for a user. The processing module is configured to generate the display control signal so that at least one user-detectable characteristic of the virtual target is varied based on the information related to the position of the user indicator or the distance between the user indicator and the event point.

### RELATED APPLICATION

This application claims priority under 35 U.S.C. §119 to German Patent Application No. 102014114742.1, filed on Oct. 10, 2014, the content of which is incorporated by reference herein in its entirety.

### TECHNICAL FIELD

Embodiments relate to input interfaces and in particular to an apparatus for generating a display control signal and a method thereof.

### BACKGROUND

Emerging technologies such as immersive environments created by 3D displaying techniques may allow a user to take place (or to be immersed) in a virtual reality that may separate him completely from the outside. It may be necessary that user input controls may move into the virtual 3D world as well, because focusing the eyes on an external input control unit may distract the user from the immersive experience.

### SUMMARY

Some embodiments relate to an apparatus for generating a display control signal. The apparatus includes an input module configured to receive a detection signal including information related to a position of a user indicator or a distance between a user indicator and an event point associated with a virtual target. The apparatus further includes a processing module configured to generate a display control signal including display information for producing an image of the virtual target by a display device for a user. The processing module is configured to generate the display control signal so that at least one user-detectable characteristic of the virtual target is varied based on the information related to the position of the user indicator or the distance between the user indicator and the event point.

Some embodiments relate to method for generating a display control signal. The method includes receiving a detection signal including information related to a position of a user indicator or a distance between a user indicator and an event point associated with a virtual target. The method further includes generating a display control signal including display information for producing an image of the virtual target by a display device for a user so that at least one user-detectable characteristic of the virtual target is varied based on the information related to the position of the user indicator or the distance between the user indicator and the event point.

### BRIEF DESCRIPTION OF THE FIGURES

Some embodiments of apparatuses and/or methods will be described in the following by way of example only, and with reference to the accompanying figures, in which

FIG. 1 shows a schematic illustration of an apparatus for generating a display control signal;

FIGS. 2A to 2C show schematic illustrations of a variation of a user-detectable characteristic of a virtual target;

FIG. 3A to 3B show schematic illustrations of a position of a user indicator or distance between a user indicator and at least one event point associated with a virtual target;

FIG. 4 shows a schematic illustration of a virtual layout of one or more virtual targets;

FIGS. 5A to 5D show schematic illustrations of various input interfaces;

FIG. 6 shows a flow chart of a method for generating a display control signal;

FIG. 7 shows a further flow chart of a method for generating a display control signal.

### DETAILED DESCRIPTION

Various example embodiments will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like or similar elements throughout the description of the figures.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

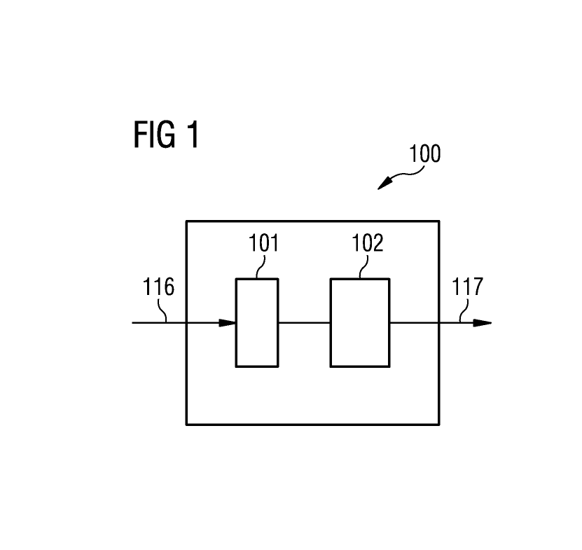

FIG. 1 shows a schematic illustration of an apparatus 100 for generating a display control signal according to an embodiment.

The apparatus 100 includes an input module 101 configured to receive a detection signal 116 including information related to a position of a user indicator or a distance between a user indicator and an event point associated with a virtual target.

The apparatus 100 further includes a processing module 102 configured to generate a display control signal 117 including display information for producing an image of the virtual target by a display device for a user. The processing module 102 is configured to generate the display control signal 117 so that at least one user-detectable characteristic of the virtual target is varied based on the information related to the position of the user indicator or the distance between the user indicator and the event point.

Due to the generation of a display control signal so that at least one user-detectable characteristic of the virtual target is varied based on the information related to the position of the user indicator or distance between the user indicator and the event point, a user may detect or receive feedback regarding how far away a user indicator may be from a virtual target, for example. Varying or changing a user-detectable characteristic, e.g. an appearance, of the virtual target may improve feedback to the user, as the user may receive direct feedback about the distance between the user indicator and a specific input object or a virtual target. This may improve a user's interaction with virtual targets generated by the processing module, for example. For example, accuracy of an interaction between the user indicator and activating an event point for triggering an event may be improved.

The apparatus 100 may be a computer, a processor or microcontroller or may be part of a computer, a processor or microcontroller, for example. The input module 101 may be an input port or input interface of a computer, a processor or a microcontroller, for example. The input module 101 of the apparatus 100 may be configured to receive the detection signal 116 from a three-dimensional (3D) sensing device which may be configured to generate the detection signal 116, for example. For example, the input module 101 may be configured to receive the detection signal 116 from a least one of a time of flight (TOF) camera, a camera for producing three-dimensional images (e.g. a 3D camera) or an ultrasonic sensor. The input module 101 may be coupled to the 3D sensing device via a wired or wireless connection, for example.

The detection signal 116 may include information related to a position of a user indicator or a distance between the user indicator (e.g. a fingertip) and an event point associated with a virtual target, for example. In some examples, the detection signal 116 may include (distance) information related to a position of a user, e.g. co-ordinate information a user indicator within a 3D sensing space of the 3D sensing device. In some examples, the detection signal 116 may include distance information related to a distance between the user indicator and a reference location (e.g. between the user indicator and the 3D sensing device, or between the user indicator and the display device).

The user indicator may be a finger, a fingertip or a body part of a user, for example. In some examples, the user indicator may be a pen, a stick, a baton, a device, a tool or appliance which may be controlled by the user.

The processing module 102 may include a processor, a microcontroller or a digital signal processor or be part of a processor, a microcontroller or a digital signal processor, for example. The processing module 102 may be configured to generate a display control signal 117 which includes display information for producing (an image of) a virtual target by a display device for a user. The display control signal 117 generated by the processing module may be received by the display device and may be used by the display device for displaying the virtual target and/or the virtual layout, for example. The display control signal 117 may include computer executable instructions which may be executed by a display device for producing the virtual targets, for example.

In some examples, the display control signal 117 may include display information for representing the virtual target on a display screen for two-dimensional presentation (e.g. a 2D display device). For example, virtual targets may be buttons or selection targets displayed on the screen. For example, the display screen may be a display monitor for a computer e.g. for a personal computer (PC) or desktop computer, or a display monitor or screen for a mobile device, a tablet device, or an all-in-one personal computer.

In some examples, the display control signal 117 may include display information for generating for a user a three-dimensional presentation (e.g. a stereoscopic display or presentation) of the virtual target by a display device for three-dimensional presentation (e.g. a 3D display device). For example, a 3D display devices used in conjunction with shutter glasses or 3D glasses may result in virtual targets may be buttons or selection targets being perceived to be displayed a distance away from the screen. For example, the virtual targets may be perceived to be arranged in a 3D space. Examples of such a display device for three-dimensional presentation may include at least one of a three-dimensional enabled display screen or a head mounted display device, for example. The displace device for three-dimensional presentation may be configured to display images which increase depth of the images perceived by a user device in comparison to a display device for two-dimensional presentation.

The variation of the at least one user-detectable characteristic of the virtual target may be a variation of a position, an optical appearance or size of the virtual target, which may be a variation in at least one dimension (or direction) in a three-dimensional space (a 3D space defined by coordinates in an x (e.g. a horizontal) direction, a y (e.g. a vertical) direction, and a z (e.g. in a forwards or backwards) direction. In some examples, the user-detectable characteristic may be a feature of the virtual target, such as a shape, size, color, or color intensity of the virtual target which may be observable (e.g. optically visible) by the user, for example. In some examples, the user-detectable characteristic may be an auditory or haptic feedback which may be sensed or observed by the user, for example.

The processing module 102 may be configured to generate the display control signal 117 so that the at least one user-detectable characteristic of the virtual target is varied based on the distance. For example, the processing module 102 may be configured to generate the display control signal 117 so that the at least one user-detectable characteristic of the virtual target is varied in proportion to information related to changes in the position of the user indicator or the distance between the user indicator and the event point. For example, the at least one user-detectable characteristic of the virtual target may be varied in proportion to changes in the position of the user indicator or to changes in the distance between the user indicator and the event point.

The processing module 102 may be configured to determine the distance between the user indicator and the event point associated with the virtual target based on the detection signal 116, for example. For example, the processing module 102 may be configured to determine the distance between the user indicator and the event point based on a position of the user indicator. For example, the processing module 102 may be configured to determine the distance based on coordinates (e.g. x, y or z coordinates) of the event point of the virtual target of a virtual layout and coordinates (e.g. x, y or z coordinates) of the position of the user indicator, for example.

The processing module 102 may be configured to trigger an event associated with the virtual target if the user indicator reaches the event point associated with the virtual target. The virtual target may be graphic or image of a button, a key of a keypad, or a 3D representation of a 3D button or a key of a keypad, for example. The virtual target may be a graphic or image which may trigger or activate an event upon interaction of the user with the virtual target. In some examples, the event point may be located at a predetermined distance (or at a predetermined coordinate location) from the represented virtual target so that the user indicator may activate or trigger the change in event even before arriving at or reaching the virtual target (e.g. at a predetermined distance from the virtual target). In other examples, the event point may be located at the represented virtual target, so that the user indicator may activate or trigger the change in event when the user indicator arrives at or reaches the event point.

The triggered event may be a change in other virtual components of the virtual layout of the display, in addition to the change in the user-detectable characteristic of the virtual target. For example, the triggered event may change the visual appearance a virtual layout of the display. For example, the triggered event may be a change in an image or scene displayed by the display device, or the trigger of an auditory (e.g. a beep or a sound) or haptic event (e.g. a buzz, movement or vibration).

Technologies such as three-dimensional (3D) time of flight cameras (ToF) and immersive environments created by 3D displaying techniques may allow a user to take place (or to be immersed) in a virtual reality that may separate him completely from the outside.

Input controls may be virtual keypads or a virtual pointer that may be touched by the fingertip of the user in space. Experiments with a virtual keyboard demonstrator of a TOF imager may show that user interaction with a virtual surface may be more difficult than with a standard keyboard. For example, the user has no feedback about the distance of its finger to an input button, at some point the finger touches the real surface and an action may be triggered just without warning in advance. The examples described herein give the user feedback when his fingertip approaches a distance where it is close before an action is triggered by his gesture.

The examples described herein offer the user visual feedback when he approaches the virtual target object (e.g. a button), that varies with the distance to the target object. By doing so the user gets information about how far his fingertip or pointing device is away from the point where an action is triggered. The examples describe how to change the appearance (layout in 2d or 3D presentation) of the target object that is responsible for triggering an action in a way that is proportional to the distance of the pointing device to it, for example.

In some examples, the processing module may be further configured to generate a user feedback control signal for varying an auditory or a haptic signal based on the information related to the position of the user indicator or the distance between the user indicator and the event point. For example, the haptic feedback may be provided to the user by using special gloves (worn by the user, for example). Audio or auditory feedback may be provided to the user by changing a tone pitch proportional to the distance, for example. In some examples, a projection of a virtual keyboard on a desk and modifying the appearance of the buttons in place may be carried out, for example.

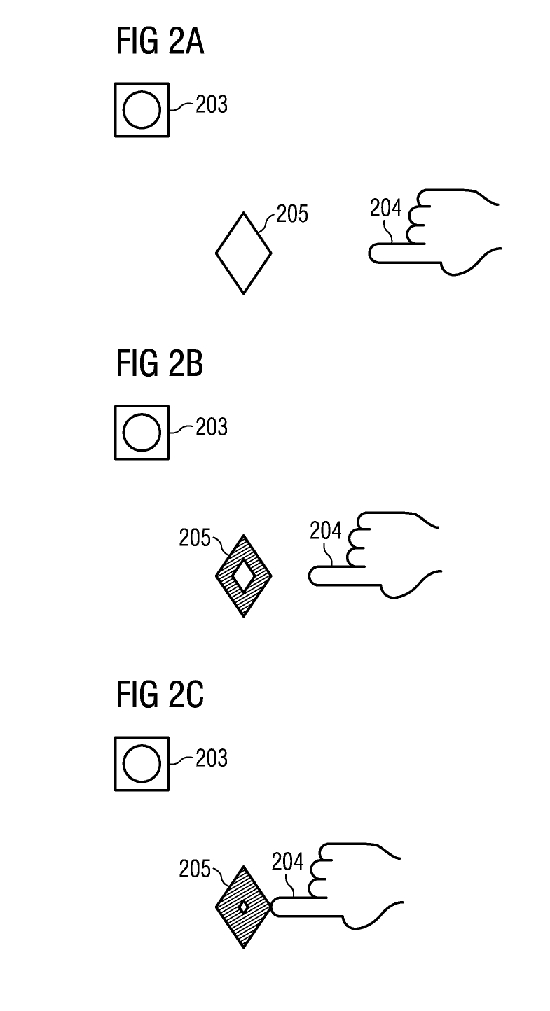

FIGS. 2A to 2C show a schematic illustration of a variation of a user-detectable characteristic of a virtual target based on the information related to a position of a user indicator or the distance between the user indicator and an event point associated with a virtual target.

FIG. 2A shows a schematic illustration where in an initial state, there may exist a 3D-depth sensing device (e.g. a 3D sensing device 203) that may be capable of locating the fingertip 204 of a user (e.g. a user indicator), for example. An input sensitive object 205 (e.g. a virtual target) may exist (or be displayed) on a PC-screen, tablet-surface or within an immersive 3D head mounted display or in other kinds of screens, for example. For example, as the user indicator may be beyond or just reaching a threshold distance for varying the object 205, the object 205 may be between 0 to 5% filled, for example. The processing module may be configured to generate the digital control signal so that the at least one user-detectable characteristic of the virtual target is varied if the distance between the user indicator 204 and the event point associated with the virtual target 205 is below a threshold distance

FIG. 2B shows that when the fingertip 204 (e.g. or a user indicator or a user pointing device) narrows (or nears) the input sensitive object 205, the (virtual) object 205 changes its layout, e.g. by filling up the interior of the object, for example. For example, as the distance between the user indicator 204 and the event point of the virtual target 205 falls below a threshold distance, the user-detectable characteristic of the virtual object is varied as the user indicator 204 moves closer to the event point. Accordingly, the object may be increasingly or gradually filled from 0% to 100%, for example.

FIG. 2C shows that when the fingertip 204 is close to the position that triggers a touch event, the object 205 may be filled nearly completely and the user may have feedback about the imminent touch event, for example. For example, the object 205 may be 90% to 100% filled, for example. Reaching the event point (or reaching the virtual target if the event point has the same coordinates as the virtual target) may trigger the event associated with the virtual target.

Changing the appearance of the input sensitive object 205 itself may be an improvement compared to a change of a cursor object on the screen. The user may get direct feedback about how far he is away from touching a specific input object and not only information about where a cursor is located on a screen. FIGS. 2A to 2C show the procedure when an event is triggered by touching an input sensitive object and that the object may be modified in proportion to the distance to it, for example.

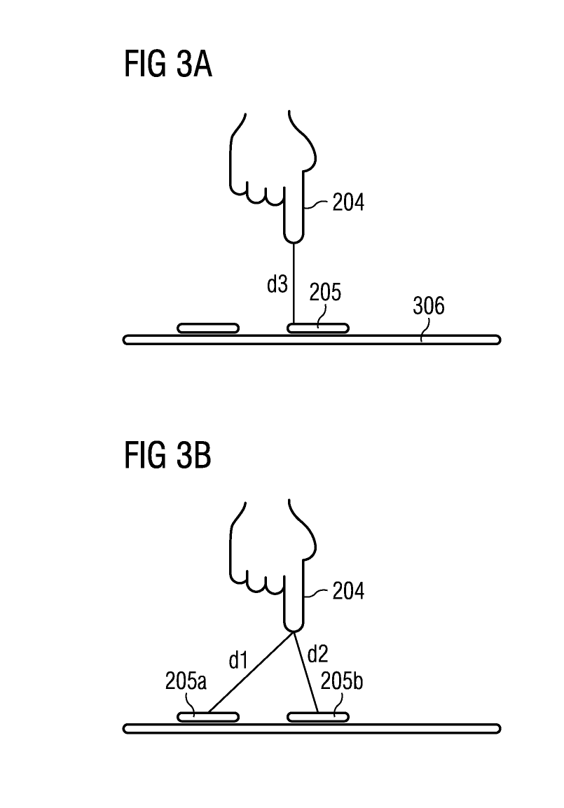

More details and aspects are mentioned in connection with embodiments described above or below (e.g. regarding the apparatus for generating the display control signal, the input module, the detection signal, the user indicator, the information related to a position of the user indicator, the distance between the user indicator and the event point, the virtual target, the processing module, the display control signal, the display information, the display device, and the user-detectable characteristic). The embodiments shown in FIGS. 2A to 2C may comprise one or more optional additional features corresponding to one or more aspects mentioned in connection with the proposed concept or one or more embodiments described above (e.g. FIG. 1) or below (e.g. FIGS. 3 to 7).

FIGS. 3A and 3B shows a schematic illustration of a position of a user indicator or the distance between a user indicator and at least one event point associated with a virtual target according to an embodiment.

FIG. 3A shows a distance measured between a user indicator 204 and an event point associated with a virtual target 205. A processing module may be configured to determine, based on the detection signal, a distance d3 between the user indicator 204 and the event point associated with the virtual target 205, for example. The processing module may be further configured to generate a display control signal so that the at least one user-detectable characteristic of the virtual target is varied based on the distance, for example. The processing module may be configured to generate the display control signal so that the at least one user-detectable characteristic of the virtual target is varied in proportion to information related to changes in the position of the user indicator or the distance between the user indicator and the event point, for example.

FIG. 3B shows another example of a distance measurement which may be carried out by a processing module. The processing module may be configured to determine, based on the detection signal, a first distance d1 between the user indicator 204 and a first event point associated with a first virtual target 205a and second distance d2 between the user indicator and a second event point associated with a second virtual target 205b, for example. The processing module may be configured to generate the display control signal including display information for representing at least one of the first and second virtual target by the display device so that at least one user detectable characteristic of at least one of the first 205a and second virtual target 205b is varied based on the first distance and the second distance. For example, the processing module may be configured to generate the display control signal so that at least one user detectable characteristic of one of the first 205a and second 205b virtual target may be varied based on a comparison of the first distance and the second distance.

For example, if a comparison of the first and the second distance indicates that the second distance d2 between the user indicator and a second event point associated with a second virtual target 205b is smaller than a first distance d1 between the user indicator 204 and a first event point associated with a first virtual target 205a, the user indicator 204 may be closer to the second virtual target than the first virtual target, for example. The processing module may then be configured to generate the display control signal so that at least one user detectable characteristic of the second virtual target 205b may be varied in proportion to information related to changes in the distance between the user indicator 204 and the second event point, for example. The first virtual target may remain unchanged, for example.

In other examples, the processing module may be configured to generate the display control signal so that a variation of at least one user-detectable characteristic of the first virtual target 205a may be based on (or may be varied in proportion to) the first distance d1 and a variation of at least one user-detectable characteristic of the second virtual target 205b may be based on (or may be varied in proportion to) the second distance d2. For example, at least one user-detectable characteristic of both the first and the second virtual target may be varied but by different amounts depending on the different distances between the user indicator 204 and each respective first and second virtual target or between the user indicator 204 and each respective first and second event point of the first and second virtual targets, for example.

As described herein, in some examples, (for example, for methods that change only the cursor itself), a distance to the (virtual) ground plane may be a measure for the distance. In other examples, the distance to the next or neighboring input objects 205b may be used instead. This may offer the user an improved feedback of a location of the user indicator with respect to a virtual target. For example, the user indicator may select from one of a plurality of virtual targets, or may select more than one virtual targets from the plurality of virtual targets, for example.

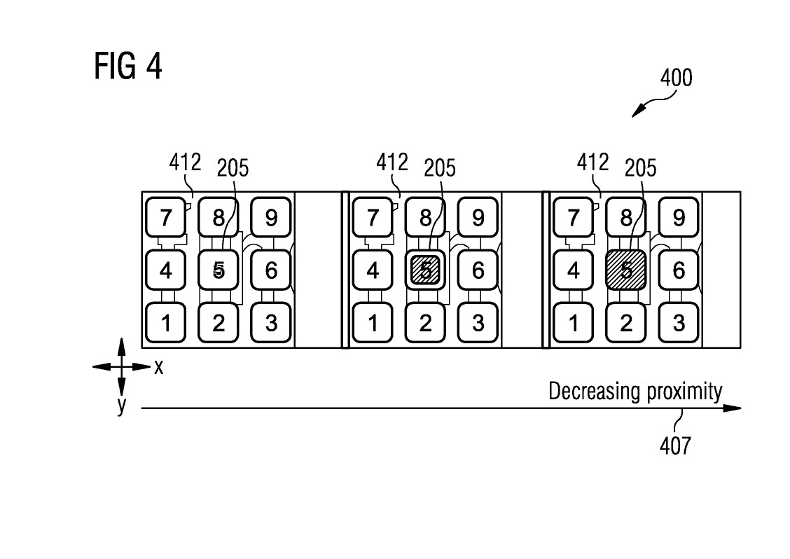

More details and aspects are mentioned in connection with embodiments described above or below (e.g. regarding the apparatus for generating the display control signal, the input module, the detection signal, the user indicator, the information related to a position of the user indicator, the distance between the user indicator and the event point, the virtual target, the processing module, the display control signal, the display information, the display device, and the user-detectable characteristic). The embodiments shown in FIGS. 3A and 3B may comprise one or more optional additional features corresponding to one or more aspects mentioned in connection with the proposed concept or one or more embodiments described above (e.g. FIGS. 1 to 2C) or below (e.g. FIGS. 4 to 7).

FIG. 4 shows a schematic illustration 400 of a virtual layout 412 of one or more virtual targets, or a virtual input area for a desktop PC or tablet.

A processing module may be configured to generate the display control signal comprising (display) information for producing a virtual keypad for a user or an image of a virtual keypad for a user. The virtual target may be one key of the virtual keypad, for example. A user may perform gestures within a virtual area in front of the screen, for example. At least one user detectable characteristic of a virtual target 205 (e.g. virtual button number “5”) of the virtual layout 412 may vary based on or in proportion to the distance between the user indicator 204 and the event point associated with the virtual target 205. For example, with decreasing distance (in the direction of arrow 407) between the user indicator 204 and the event point associated with the virtual target 205, the virtual target 205 may become more prominent, or the virtual target may change in shape, size, color, or color intensity, for example. An event may be triggered when the user indicator 204 reaches the event point of the virtual target. For example, the event may be triggered when the user indictor 204 arrives at a predetermined distance from the virtual target 205, which may be designated as an event point for the virtual target 205, for example.

In some examples, a 2D screen (e.g. a display screen) may be used, where an application may be shown and the user may operate with the application by performing operations on the virtual area in front of this screen, for example. The graphics in FIG. 4 show the visual feedback on a 2D (display) screen of the application when the user's finger approaches the input object on the plane of a virtual keypad. With decreasing distance between the finger and the input object mentioned above, the visual feedback on the 2D screen may become more prominent until it completely covers the virtual object when the event is triggered.

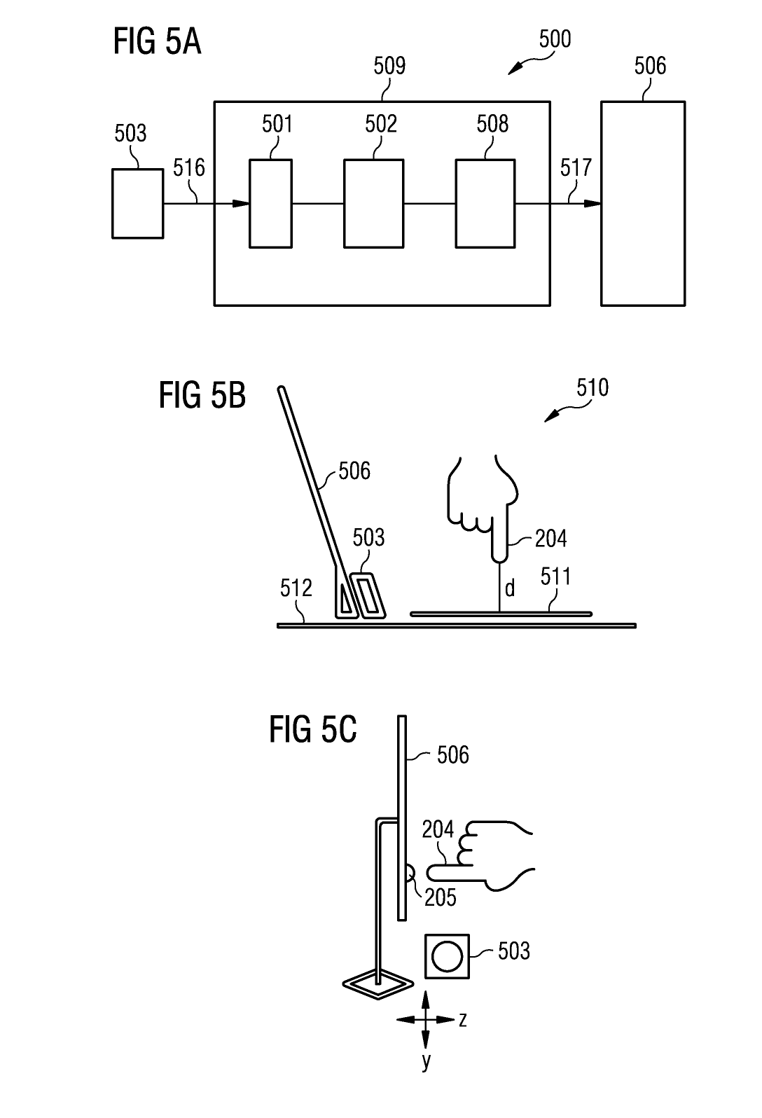

More details and aspects are mentioned in connection with embodiments described above or below (e.g. regarding the apparatus for generating the display control signal, the input module, the detection signal, the user indicator, the information related to a position of the user indicator, the distance between the user indicator and the event point, the virtual target, the processing module, the display control signal, the display information, the display device, and the user-detectable characteristic). The embodiment shown in FIG. 4 may comprise one or more optional additional features corresponding to one or more aspects mentioned in connection with the proposed concept or one or more embodiments described above (e.g. FIGS. 1 to 3B) or below (e.g. FIGS. 5 to 7).

FIG. 5A shows an input interface 500 according to an embodiment.

The input interface 500 includes a three-dimensional sensing device 503 configured to generate a detection signal 516 including information related to a position of a user indicator or a distance between a user indicator and an event point associated with a virtual target. The input interface 500 may include an apparatus 509 for generating a display control signal 517. The input interface 500 may further include a display device 506 configured to produce an image of the virtual target for a user based on the display control signal 517. The apparatus 509 includes an input module 501 and a processing module 502. The apparatus 509 including the input module 501 and the processing module 502 may be similar to the apparatuses described with respect to FIGS. 1 to 4, for example.

The apparatus 509 may further include an output interface 508 (e.g. a video port), which may be configured to provide the digital control signal to the display device 506, for example.

Due to the variation of at least one user-detectable characteristic of the virtual target based on the information related to the position of the user indicator or the distance between the user indicator and the event point, a user may detect or receive feedback on how far away a user indicator may be from a virtual target, for example. Varying or changing a user-detectable characteristic, e.g. an appearance, of the virtual target may improve feedback to the user, as the user may receive direct feedback about the distance between the user indicator and a specific input object or a virtual target.

FIG. 5B shows a schematic illustration of an input interface including a display device 506 (e.g. a screen) and a 3D sensing device 503. The input interface may also include an apparatus for generating a display control signal, for example. For example, the display device 506 may include a tablet or an All-in-one PC. For example, the display device 506 may be a display screen for a two-dimensional presentation of an image or a virtual layout. A 3D camera (e.g. 503) may be placed in front of it (e.g. the display device 506) or may be integrated into the display device 506, for example. A virtual keyboard area may exist on the desk 512, for example. The distance d may decrease when the fingertip moves towards a virtual button (or a location on the desk 512 or a virtual ground plane 511 which may be in proximity to the desk). This may let the button (or virtual target) displayed on the screen or display device 506 change its visual appearance or at least one user-detectable characteristic of the virtual target, for example. This may be useful for providing visual feedback for the user as the virtual keyboard area (or the area which exists on the desk 512) may be a sensing area on which user gestures may be performed, and particularly if no physical, tactile or visual keyboard may otherwise exist for the user. In some examples, a projection of a virtual keyboard on a desk and modifying the appearance of the buttons in place may be carried out, for example.

FIG. 5C shows a schematic illustration of an input interface including a display device 506 (e.g. a screen) and a 3D sensing device 503. The input interface may also include an apparatus for generating a display control signal, for example.

For example, the display device 506 may be a display screen for a three-dimensional presentation of an image or a virtual layout. The virtual layout may include one or more virtual objects or virtual targets arranged in one or more virtual planes. For example, the display device 506 may be configured to display an on-Screen 3D input keypad for 3D Vision screens, for example.

Technologies may exist that allow the generation of a real 3D view on a flat panel screen where the user may wear shutter glasses. It may possible to generate an out-of-the-screen effect, which means that the user may have the impression that an object is closer to him than the real screen surface. Using the proposed solution a user input object (or virtual target 205) may be shown at the screen (or display device 506) that changes its appearance in a way that the impact point (or event point) to trigger an action may be in front of the screen. Using a 3D depth sensing device 503, the appearance of a virtual 3D input object (or virtual target 205) may be adapted in dependency of the distance of the input device (or user indicator 204) to it. For example, the variation of the at least one user-detectable characteristic of the virtual target may be a variation of a position, an optical appearance or size of the virtual target in at least one dimension (or direction) in a three-dimensional space (a 3D space defined by coordinates on an x-axis e.g. a horizontal direction, a y-axis, e.g. a vertical direction, and a z-axis, e.g. in a forwards or backwards direction). For example, variation of the virtual target in along the x-axis or y-axis may be in directions parallel to a planar surface of a display screen. For example, variation of the virtual target along the z-axis may be in a direction perpendicular to a planar surface of the display screen.

For example, the processing module may be configured to trigger a change at least one user-detectable characteristic of the virtual target if the user indicator reaches the event point associated with the virtual target. For example, the processing module may generate a display control signal such that the virtual target may vary in position when the user indicator reaches the event point associated with the virtual target. For example, the event point may be located at a constant distance from a main displaying surface or screen of the display device 506, for example. As the processing module may determine the distance of the user indicator from the display device 506 (or the display screen), the processing module may determine a magnitude of a variation of a position, an optical appearance or size of the virtual target when the user indicator reaches the event point associated with the virtual target.

For example, the change may be implemented using an out-of-the-screen effect (e.g. in a z-direction) and may move the input object (or virtual target 205) or parts of it closer to the input device (or user indicator 204). FIG. 5C shows a snap-shot of an ongoing user interaction. The fingertip (or user indicator 204) may be moving to the target input object (or virtual target 205) and during approximation the input objects (or virtual target 205) may move out of the screen (or display device 506) and may meet the fingertip (or user indicator 204) at the virtual plane where an event for touching the object is triggered (e.g. at the event point). This may allow the user to interact with an application without a physical keyboard and may avoid that the user soils the screen surface with his fingers because the trigger point is moved away from the screen surface, for example.

FIG. 5D shows a schematic illustration of a further input interface including a display device 506 (e.g. a head-mounted display device) and a 3D sensing device 503. The input interface may further include an apparatus for generating a display control signal, for example.

The display device 506 may be configured to display a virtual 3D input keypad for virtual reality head-mounted displays, for example. In an example, the input interface may be used for complete immersive 3D environments using head mounted 3D-glasses. Within the 3D environment the user 513 may see (e.g. in a 3D world of a game or application), a (virtual) keypad which may be displayed in space. For example, the user may see a virtual layout 412 of a keypad on a virtual screen. Using a 3D-depth sensing device that may be mounted on the 3D glasses (e.g. 506) or at some place around the user, his hand (or an image of the user indicator 204) may be captured (by the 3D sensing device) and a semi-realistic representation (or an image) of his hand (or user indicator 204) may be shown as a cursor in the 3D environment. When the cursor approaches the virtual keyboard, the buttons of the keyboard (e.g. one or more virtual targets) may change (e.g. a cone that gets bigger proportional to the distance to the cursor). For example, one or more virtual targets 205a, 205b, 205c of a plurality of virtual targets of the virtual layout 412 may be varied, so that at least one user-detectable characteristic of the one or more virtual targets 205a, 205b, 205c may be respectively varied based on a distance between the user indicator and each respective virtual target. As the distance between each virtual target (e.g. 205a, 205b, 205c) may be different, the user-detectable characteristic of each virtual target may be different from each other.

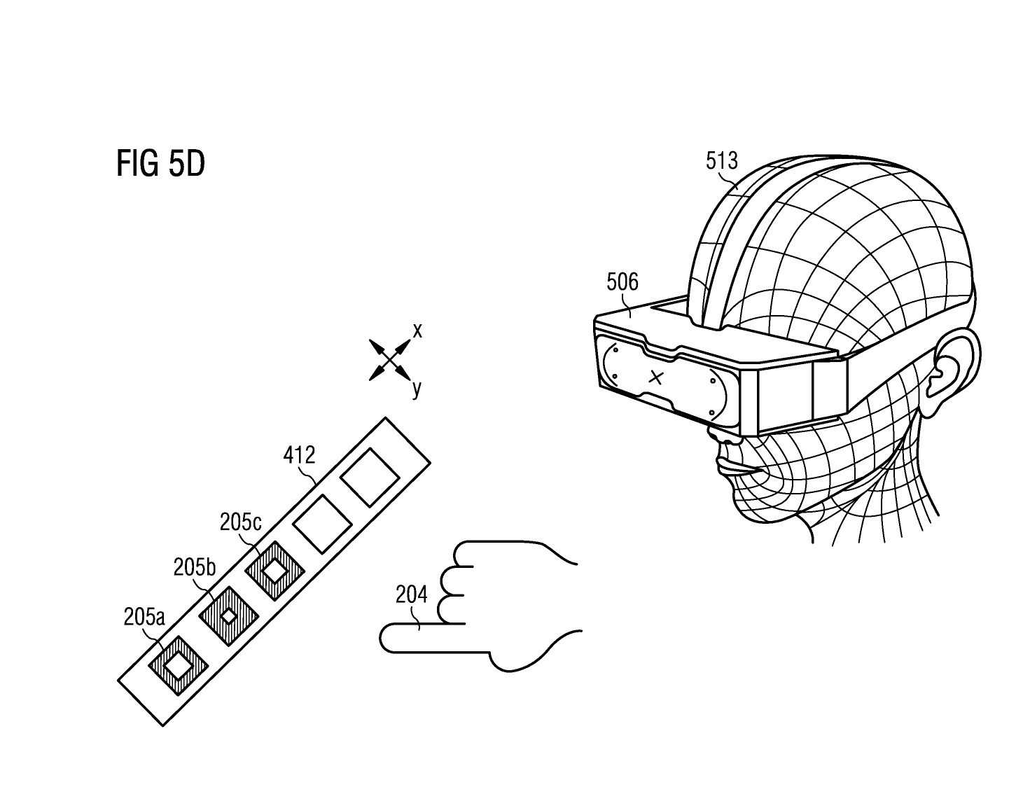

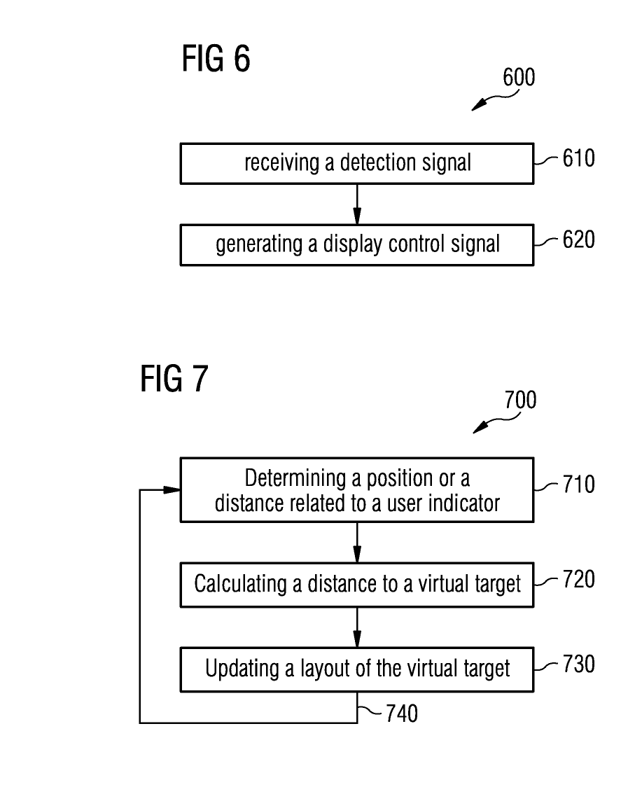

More details and aspects are mentioned in connection with embodiments described above or below (e.g. regarding the apparatus for generating the display control signal, the input module, the detection signal, the user indicator, the information related to a position of the user indicator, the distance between the user indicator and the event point, the virtual target, the processing module, the display control signal, the display information, the display device, and the user-detectable characteristic). The embodiments shown in FIGS. 5A to 5D may comprise one or more optional additional features corresponding to one or more aspects mentioned in connection with the proposed concept or one or more embodiments described above (e.g. FIGS. 1 to 4) or below (e.g. FIGS. 6 and 7).

FIG. 6 shows a flow chart of a method 600 for generating a display control signal according to an embodiment.

The method 600 includes receiving 610 a detection signal including information related to a position of a user indicator or a distance between a user indicator and an event point associated with a virtual target.

The method 600 further includes generating 620 a display control signal including display information for producing an image of the virtual target by a display device for a user so that at least one user-detectable characteristic of the virtual target is varied based on the information related to the position of the user indicator or the distance between the user indicator and the event point.

Due to the variation of at least one user-detectable characteristic of the virtual target based on the information related to the position of the user indicator or the distance between the user indicator and the event point, a user may detect or receive feedback on how far away a user indicator may be from a virtual target, for example. Varying or changing a user-detectable characteristic, e.g. an appearance, of the virtual target may improve feedback to the user, as the user may receive direct feedback about the distance between the user indicator and a specific input object or a virtual target.

The method 600 may further include determining the distance between the user indicator and the event point associated with the virtual target based on the detection signal, for example.

The method 600 may further include generating the display control signal so that at least one user-detectable characteristic of the virtual target is varied in proportion to the information related to changes in the position of the user indicator or the distance between the user indicator and the event point, for example.

More details and aspects are mentioned in connection with embodiments described above or below (e.g. regarding the apparatus for generating the display control signal, the input module, the detection signal, the user indicator, the information related to a position of the user indicator, the distance between the user indicator and the event point, the virtual target, the processing module, the display control signal, the display information, the display device, and the user-detectable characteristic). The embodiment shown in FIG. 6 may comprise one or more optional additional features corresponding to one or more aspects mentioned in connection with the proposed concept or one or more embodiments described above (e.g. FIGS. 1 to 5D) or below (e.g. FIG. 7).

FIG. 7 shows a flow chart of a method 700 for generating a display control signal according to an embodiment.

The method 700 may include determining 710 a position or a distance related to a user indicator. This determination may be carried out by a 3D camera, such as a TOF camera for carrying out depth sensing measurements using TOF techniques, for example.

The method 700 may further include calculating 720 a distance to a virtual target (e.g. a distance between the user indicator and one or more virtual targets).

The method 700 may further include updating 730 a layout of the virtual target. (e.g. so that a user-detectable characteristic of at least one virtual target may be varied in proportion to a distance between the user indicator and the virtual target).

The processes 710 to 730 may be repeated 740, e.g. continuously at a high frame rate (e.g. greater than 50 Hz, for example), for a number of cycles as required.

More details and aspects are mentioned in connection with embodiments described above or below (e.g. regarding the apparatus for generating the display control signal, the input module, the detection signal, the user indicator, the information related to a position of the user indicator, the distance between the user indicator and the event point, the virtual target, the processing module, the display control signal, the display information, the display device, and the user-detectable characteristic). The embodiment shown in FIG. 7 may comprise one or more optional additional features corresponding to one or more aspects mentioned in connection with the proposed concept or one or more embodiments described above (e.g. FIGS. 1 to 6) or below.

Various embodiments relate to a method for user interaction in a 3D immersive environment.

Example embodiments may further provide a computer program having a program code for performing one of the above methods, when the computer program is executed on a computer or processor. A person of skill in the art would readily recognize that acts of various above-described methods may be performed by programmed computers. Herein, some example embodiments are also intended to cover program storage devices, e.g., digital data storage media, which are machine or computer readable and encode machine-executable or computer-executable programs of instructions, wherein the instructions perform some or all of the acts of the above-described methods. The program storage devices may be, e.g., digital memories, magnetic storage media such as magnetic disks and magnetic tapes, hard drives, or optically readable digital data storage media. Further example embodiments are also intended to cover computers programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. It will thus be appreciated that those skilled in the art will be able to devise various arrangements that, although not explicitly described or shown herein, embody the principles of the disclosure and are included within its spirit and scope. Furthermore, all examples recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions. Moreover, all statements herein reciting principles, aspects, and embodiments of the disclosure, as well as specific examples thereof, are intended to encompass equivalents thereof.

Functional blocks denoted as “means for . . . ” (performing a certain function) shall be understood as functional blocks comprising circuitry that is configured to perform a certain function, respectively. Hence, a “means for s.th.” may as well be understood as a “means configured to or suited for s.th.”. A means configured to perform a certain function does, hence, not imply that such means necessarily is performing the function (at a given time instant).

Functions of various elements shown in the figures, including any functional blocks labeled as “means”, “means for providing a sensor signal”, “means for generating a transmit signal”, etc., may be provided through the use of dedicated hardware, such as “a signal provider”, “a signal processing unit”, “a processor”, “a controller”, etc. as well as hardware capable of executing software in association with appropriate software. Moreover, any entity described herein as “means”, may correspond to or be implemented as “one or more modules”, “one or more devices”, “one or more units”, etc. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

It should be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Furthermore, the following claims are hereby incorporated into the Detailed Description, where each claim may stand on its own as a separate embodiment. While each claim may stand on its own as a separate embodiment, it is to be noted that—although a dependent claim may refer in the claims to a specific combination with one or more other claims—other embodiments may also include a combination of the dependent claim with the subject matter of each other dependent or independent claim. Such combinations are proposed herein unless it is stated that a specific combination is not intended. Furthermore, it is intended to include also features of a claim to any other independent claim even if this claim is not directly made dependent to the independent claim.

It is further to be noted that methods disclosed in the specification or in the claims may be implemented by a device having means for performing each of the respective acts of these methods.

Further, it is to be understood that the disclosure of multiple acts or functions disclosed in the specification or claims may not be construed as to be within the specific order. Therefore, the disclosure of multiple acts or functions will not limit these to a particular order unless such acts or functions are not interchangeable for technical reasons. Furthermore, in some embodiments a single act may include or may be broken into multiple sub acts. Such sub acts may be included and part of the disclosure of this single act unless explicitly excluded.

1. An apparatus for generating a display control signal, comprising:
an input module configured to receive a detection signal comprising information related to a position of a user indicator or a distance between a user indicator and an event point associated with a virtual target; and
a processing module configured to generate a display control signal comprising display information for producing an image of the virtual target by a display device for a user, wherein the processing module is configured to generate the display control signal so that at least one user-detectable characteristic of the virtual target is varied based on the information related to the position of the user indicator or the distance between the user indicator and the event point.

2. The apparatus according to claim 1, wherein the display control signal comprises display information for representing the virtual target on a display screen for two-dimensional presentation.

3. The apparatus according to claim 1, wherein the display control signal comprises display information for generating, for a user, a three-dimensional presentation of the virtual target by a display device for three-dimensional presentation.

4. The apparatus according to claim 3, wherein the display device for three-dimensional presentation comprises at least one of a three-dimensional enabled display screen or a head mounted display device.

5. The apparatus according to claim 1, wherein a variation of the at least one user-detectable characteristic of the virtual target is a variation of a position, an optical appearance or size of the virtual target.

6. The apparatus according to claim 1, wherein the processing module is further configured to generate a user feedback control signal for varying an auditory or a haptic signal based on the information related to the position of the user indicator or the distance between the user indicator and the event point.

7. The apparatus according to claim 1, wherein the processing module is configured to determine the distance between the user indicator and the event point associated with the virtual target based on the detection signal, and to generate the display control signal so that the at least one user-detectable characteristic of the virtual target is varied based on the distance.

8. The apparatus according to claim 1, wherein the processing module is configured to generate the display control signal so that the at least one user-detectable characteristic of the virtual target is varied in proportion to information related to changes in the position of the user indicator or the distance between the user indicator and the event point.

9. The apparatus according to claim 1, wherein the processing module is configured to generate the display control signal so that the at least one user-detectable characteristic of the virtual target is varied if the distance between the user indicator and the event point associated with the virtual target is below a threshold distance.

10. The apparatus according to claim 1, wherein the processing module is configured to determine, based on the detection signal, a first distance between the user indicator and a first event point associated with a first virtual target and a second distance between the user indicator and a second event point associated with a second virtual target;
wherein the processing module is configured to generate the display control signal comprising display information for representing at least one of the first virtual target or the second virtual target by the display device so that at least one user-detectable characteristic of at least one of the first virtual target or the second virtual target is varied based on the first distance and the second distance.

11. The apparatus according to claim 10, wherein the processing module is configured to generate the display control signal so that a variation of at least one user-detectable characteristic of the first virtual target is based on the first distance and a variation of at least one user-detectable characteristic of the second virtual target is based on the second distance.

12. The apparatus according to claim 10, wherein the processing module is configured to generate the display control signal so that at least one user-detectable characteristic of one of the first virtual target or the second virtual target is varied based on a comparison of the first distance and the second distance.

13. The apparatus according to claim 1, wherein the processing module is configured to trigger an event associated with the virtual target if the user indicator reaches the event point associated with the virtual target.

14. The apparatus according to claim 1, wherein the user indicator is a finger of the user, a stick controlled by the user, or a pen controlled by the user.

15. The apparatus according to claim 1, wherein the event point is located at a predetermined distance from the virtual target or located at the virtual target.

16. The apparatus according to claim 1, wherein the input module is configured to receive the detection signal from a least one of a time of flight camera, a camera for producing three-dimensional images, or an ultrasonic sensor.

17. The apparatus according to claim 1, wherein the processing module is configured to generate the display control signal comprising display information for producing a virtual keypad for a user, wherein the virtual target is one key of the virtual keypad.

18. An input interface, comprising
a three-dimensional sensing device configured to generate a detection signal comprising information related to a position of a user indicator or a distance between a user indicator and an event point associated with a virtual target;
an apparatus according to claim 1; and
a display device configured to produce an image of the virtual target for a user based on the display control signal.

19. A method for generating a display control signal, the method comprising:
receiving a detection signal comprising information related to a position of a user indicator or a distance between a user indicator and an event point associated with a virtual target; and
generating a display control signal comprising display information for producing an image of a virtual target by a display device for a user so that at least one user-detectable characteristic of the virtual target is varied based on the information related to the position of the user indicator or the distance between the user indicator and the event point.

20. The method according to claim 19, further comprising determining the distance between the user indicator and the event point associated with the virtual target based on the detection signal.
